(19) United States
(12) Patent Application Publication
(10) Pub. No.: US 2022/0079195 A1
(43) Pub. Date: Mar. 17, 2022

(54) TEA BAG FOR BROTH CONTAINING RED-BANDED LOBSTER POWDER AND METHOD FOR PREPARING SAME

(71) Applicant: OLLEBADANG FISHERMEN'S UNION CORPORATION, Jeju-si (KR)

(72) Inventor: SengHoo KIM, Jeju-si (KR)

(21) Appl. No.: 17/472,733

(22) Filed: Sep. 13, 2021

(30) Foreign Application Priority Data
Sep. 15, 2020 (KR) 10-2020-0118459
Sep. 7, 2021 (KR) 10-2021-0119377

(51) Int. Cl. A23L 23/10

(52) U.S. Cl. CPC A23L 23/10; A23J 3/04

(57) ABSTRACT

The present disclosure relates to a tea bag for broth containing red-banded lobster powder and a method for preparing the same. More specifically, a method for preparing a tea bag for broth containing red-banded lobster powder according to an embodiment of the present disclosure includes: steaming raw red-banded lobsters at 50° C. to 100° C. for 2 to 10 hours; drying the raw red-banded lobsters at 40° C. to 70° C. for 5 to 40 hours; pulverizing the dried raw red-banded lobsters; and roasting the pulverized red-banded lobster powder at 100° C. to 250° C. for 10 to 120 minutes. Thus, it is possible to provide a tea bag for broth that may minimize the fishy and miscellaneous smell of a red-banded lobster, and may brew a broth with excellent flavor and sensory properties by utilizing the flavor of a red-banded lobster.

### CROSS-REFERENCE TO RELATED APPLICATIONS

This application claims the priority of Korean Patent Application No. 10-2020-0118459 filed on Sep. 15, 2020, and Korean Patent Application No. 10-2021-0119377 filed on Sep. 7, 2021, in the Korean Intellectual Property Office, the disclosure of which is incorporated herein by reference.

### BACKGROUND

### Field

The present specification relates to a tea bag for broth containing red-banded lobster powder and a method for preparing the same, and more particularly, to a tea bag for broth containing red-banded lobster powder capable of brewing broth with a cool and light umami taste of red-banded lobsters and utilize a by-product of red-banded lobster and a method for preparing the same.

### Description of the Related Art

A red-banded lobster is a crustacean in the family Metanephrops thomsoni included in the order Decapoda that is mainly caught in Jeju, South Korea, and its scientific name is Metaephrops thomsoni (red-banded lobster). The red-banded lobster has a very hard shell, and includes meat with a texture similar to shrimp meat inside the hard shell. The red-banded lobster is mainly eaten boiled or used as ingredients for seafood soup, and is aged in soy sauce or eaten raw. In particular, the red-banded lobster has a good texture and rich meat quality. In addition, although the taste and nutrition are excellent, the price is relatively low, so the red-banded lobster is suitable for use as a food ingredient.

In recent years, as the demand for red-banded lobsters has increased significantly, the need for treatment and management of inedible parts except for the meat of red-banded lobsters or by-products such as small-sized red-banded lobsters with poor marketability is increasing. For example, the inedible parts of red-banded lobsters, such as shells and heads, occur about 200% of the actual processed products of red-banded lobsters. Accordingly, there is a need to find a way to improve the marketability and expand the market of processed red-banded lobsters by providing processed food by utilizing the inedible parts and by-products of red-banded lobsters.

### SUMMARY

Accordingly, an aspect of the present disclosure is directed to providing a tea bag for broth containing red-banded lobster powder utilizing red-banded lobsters and a method for preparing the same.

In addition, an aspect of the present disclosure is directed to providing a tea bag for broth capable of brewing broth that can satisfy consumer preferences by steaming, drying, pulverizing, and roasting raw red-banded lobsters, thereby utilizing the flavor of a red-banded lobster and removing the fishy and miscellaneous smell.

An aspect of the present disclosure is directed to saving wasted by-products and creating new added value by utilizing the inedible parts of red-banded lobsters such as shells and heads.

The aspects of the present disclosure are not limited to those mentioned above, and other aspects not mentioned herein will be clearly understood by those skilled in the art from the following description.

A method for preparing a tea bag for broth containing red-banded lobster powder according to an embodiment of the present disclosure includes: steaming raw red-banded lobsters at 50° C. to 100° C. for 2 to 10 hours; drying the raw red-banded lobsters at 40° C. to 70° C. for 5 to 40 hours; pulverizing the dried raw red-banded lobsters; and roasting the pulverized red-banded lobster powder at 100° C. to 250° C. for 10 to 120 minutes.

According to another feature of the present disclosure, after the drying, the method further includes separating meat from the dried raw red-banded lobsters to obtain red-banded lobster shells, in which the dried raw red-banded lobsters may be red-banded lobster shells.

According to another feature of the present disclosure, the pulverized red-banded lobster powder has a particle size of 0.1 mm to 10 mm, and a ratio of powder having a particle size of 3 mm or more to a powder having a particle size of less than 3 mm may be 1:2 to 1:1.

According to another feature of the present disclosure, the method may further include subdividing the roasted red-banded lobster powder into 2 g to 4 g and packaging the powder in a tea bag.

According to another feature of the present disclosure, the method further includes adding 20 to 50 parts by weight of vegetable soup powder based on 100 parts by weight of the roasted red-banded lobster powder to the tea bag, in which the vegetable soup powder may include at least one of pepper powder, mushroom powder, green onion powder, carrot powder, and seaweed powder.

The details of other embodiments are included in the detailed description and drawings.

The present disclosure may provide a novel processed food using red-banded lobsters.

The present disclosure may provide a tea bag for broth that is rich and excellent in umami taste.

The present disclosure may provide a tea bag for broth, which is prepared in the form of a tea bag and is easy to use while maintaining a constant taste during cooking.

The present disclosure may provide a tea bag for broth capable of minimizing the fishy and miscellaneous smell of a red-banded lobster and utilizing the flavor of a red-banded lobster to brew broth excellent in flavor and sensory properties.

The present disclosure may provide an additional food ingredient by using the inedible parts of a red-banded lobster.

The advantages according to the present disclosure are not limited to those mentioned above, and more various advantages are included in the present specification.

### BRIEF DESCRIPTION OF THE DRAWINGS

FIG. 1 is a flowchart illustrating a method for preparing a tea bag for broth containing red-banded lobster powder according to an embodiment of the present disclosure.

FIG. 2 is an image of a tea bag for broth containing red-banded lobster powder prepared according to an embodiment of the present disclosure.

### DETAILED DESCRIPTION OF THE EMBODIMENT

Hereinafter, preferred embodiments of the present disclosure will be described. The present disclosure may, however, be embodied in many different forms and should not be construed as being limited to the embodiments set forth herein. Rather, these embodiments are provided so that this disclosure will be thorough and complete, and will fully convey the scope of the invention to those skilled in the art.

The advantages and features of the present disclosure and methods of achieving them will be apparent from the embodiments that will be described in detail with reference to the accompanying drawings. It should be noted, however, that the present disclosure is not limited to the following embodiments, and may be implemented in various different forms. Rather the embodiments are provided so that this disclosure will be thorough and complete and will fully convey the scope of the present disclosure to those skilled in the technical field to which the present disclosure pertains, and the present disclosure will only be defined by the appended claims.

In a case where terms “comprise,” “have,” and “include” described in the present specification are used, another part may be added unless a more limiting term, such as “only,” is used. The terms of a singular form may include plural forms unless referred to the contrary.

In construing an element, the element is construed as including an error or tolerance range even where no explicit description of such an error or tolerance range is provided.

Although the terms “first,” “second,” and the like may be used herein to describe various elements, these elements should not be limited by these terms as they are not used to define a particular order. These terms are used only to distinguish one element from another. For example, a first element could be termed a second element without departing from the scope of the present disclosure.

Features of various embodiments of the present disclosure may be partially or overall coupled to or combined with each other, and may be variously inter-operated with each other and driven technically, as those skilled in the art can sufficiently understand. Embodiments of the present disclosure may be carried out independently from each other, or may be carried out in association with each other.

Hereinafter, with reference to the drawings, a method for preparing a tea bag for broth containing red-banded lobster powder according to an embodiment of the present disclosure will be described.

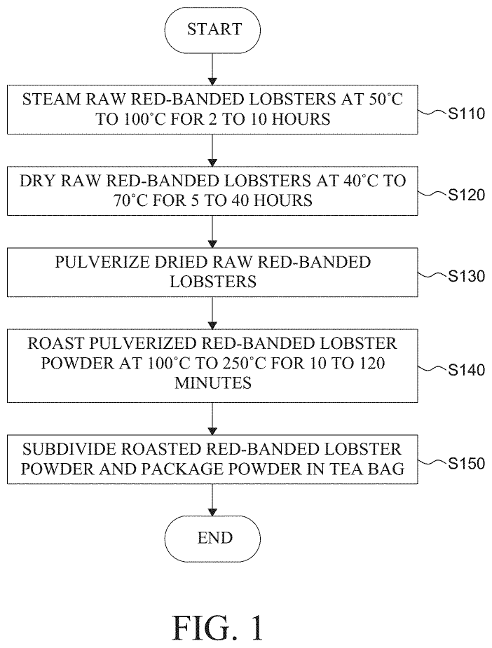

FIG. 1 is a flowchart illustrating a method for preparing a tea bag for broth containing red-banded lobster powder according to an embodiment of the present disclosure.

Referring to FIG. 1, a method for preparing a tea bag for broth containing red-banded lobster powder according to an embodiment of the present disclosure includes: steaming raw red-banded lobsters at 50° C. to 100° C. for 2 to 10 hours (S110); drying the raw red-banded lobsters at 40° C. to 70° C. for 5 to 40 hours (S120); pulverizing the dried raw red-banded lobsters (S130); roasting the pulverized red-banded lobster powder at 100° C. to 250° C. for 10 to 120 minutes (S140); and subdividing the roasted red-banded lobster powder and packaging the powder in a tea bag (S150).

First, the raw red-banded lobsters are steamed at 50° C. to 100° C. for 2 to 10 hours (S110).

As a raw red-banded lobster, a fresh living red-banded lobster or a frozen product may be used. The raw red-banded lobster may be used by removing impurities or salts through a washing process.

In addition, the raw red-banded lobster may be aged through pre-treatment to alleviate the fishy smell and improve the flavor. For example, the pre-treatment of a red-banded lobster may include, but is not limited to, refrigeration drying treatment, hot air drying treatment, smoking treatment, and the like.

The washed red-banded lobsters are steamed and cooked in a steamer at 50° C. to 100° C. for 2 hours to 10 hours. The raw red-banded lobsters may be steamed at 55° C. to 70° C. for 4 to 6 hours, but is not limited thereto. Through the steaming process, the outside and inside of the raw red-banded lobsters are sufficiently cooked.

Next, the cooked raw red-banded lobsters are dried at 40° C. to 70° C. for 5 hours to 40 hours (S120).

The raw red-banded lobsters that have been cooked through the steaming process contain moisture, so it goes through a drying process to obtain powder from the raw red-banded lobsters. The drying process may be performed at 40° C. to 70° C. for 5 hours to 40 hours, and may be performed at about 50° C. for 12 hours, but is not limited thereto.

In the present disclosure, the red-banded lobster powder may include both the edible parts of meat, as well as the inedible parts of heads or shells of red-banded lobsters. In other words, through the pulverization process performed later on the dried raw red-banded lobsters, it is possible to obtain red-banded lobster powder formed from the meat as well as heads and shells of red-banded lobsters.

In the present disclosure, the red-banded lobster powder may be prepared from only the inedible parts. In other words, the edible part, which is the meat, is removed from the cooked raw red-banded lobsters through the steaming process, and then a subsequent process is undergone using only the inedible parts, which are heads or shells of red-banded lobsters, to obtain red-banded lobster powder consisting only of the inedible parts.

Red-banded lobsters have very thick shells, so they have a very high proportion of inedible parts such as heads and shells. Accordingly, it is necessary to use the remaining parts after removing the meat of red-banded lobsters that consumers want. In the present disclosure, there may be provided a tea bag for broth containing red-banded lobster powder consisting only of inedible parts using the inedible parts from which the meat has been removed from red-banded lobsters.

As described above, in the case of preparing the red-banded lobster powder consisting only of inedible parts, separating the meat from raw red-banded lobsters before or after a drying process to obtain inedible parts of the red-banded lobsters may be further included. For example, in order to obtain undried meat from the raw red-banded lobsters, a process of separating the meat from the raw red-banded lobsters may be performed before the drying process of the raw red-banded lobsters. Alternatively, in order to obtain dried meat from the raw red-banded lobsters, a process of separating the meat from the raw red-banded lobsters may be performed after the drying process of the raw red-banded lobsters. In other words, in the case of preparing a separate processed food using the meat of the red-banded lobsters, the order of the process of separating the meat from the raw red-banded lobsters may be adjusted according to the shape of the meat of the red-banded lobsters required in a series of processes of the present disclosure.

The dried raw red-banded lobsters are pulverized (S130).

Specifically, the dried raw red-banded lobsters may be put in a pulverizer and pulverized to a particle size of 0.1 mm to 10 mm. The pulverization process may be performed through a cutter, a pulverizer and a sorter generally used in the pertinent technical field. For example, the dried raw red-banded lobsters may be pulverized in a powder form through a rotary pulverizer, but are not limited thereto. By pulverizing the raw red-banded lobsters in a powder form, the surface area is increased so that the pulverized red-banded lobsters may be brewed in broth in a short time even when packaged in a tea bag.

When the size of the pulverized particles is less than 0.1 mm, there is a risk that the red-banded lobster powder will be discharged from a tea bag when brewed in broth using the tea bag for broth. When the size of the pulverized particles is more than 10 mm, the broth may not be sufficiently brewed and the flavor may not be satisfactory.

When the size of the pulverized particles satisfies a certain distribution, the flavor and sensory properties may be further improved by the red-banded lobsters when the broth is brewed using a tea bag for broth. For example, a ratio of powder having a particle size of 3 mm or more to powder having a particle size of less than 3 mm may be 1:2 to 1:1. More specifically, a ratio of powder having a particle size of 3 mm or more to powder having a particle size of less than 3 mm to 1 mm or more may be 2:1:2, but is not limited thereto.

The pulverized red-banded lobster powder is roasted at 100° C. to 250° C. for 10 minutes to 120 minutes (S140).

By roasting the pulverized red-banded lobster powder, the fishy and miscellaneous smell may be removed while maintaining the original taste of red-banded lobsters. Accordingly, when brewing broth using a tea bag, a unique taste may be brewed within a short time, and the taste may be maintained for a long time.

The roasting process may be performed through a roasting machine commonly used in the pertinent technical field or in the food field. Specifically, the roasting process may be performed at 100° C. to 250° C. for 10 minutes to 120 minutes, and more specifically, at 150° C. to 200° C. for 20 minutes to 60 minutes. By roasting the red-banded lobster powder in the above temperature range in the method for preparing a tea bag for broth containing red-banded lobster powder according to an embodiment of the present disclosure, it is possible to minimize the fishy and miscellaneous smell of a red-banded lobster and improve flavor and sensory properties.

The method may further include cooling the roasted red-banded lobster powder after the roasting process. Although not limited thereto, by cooling the roasted red-banded lobster powder, it is possible to maintain the original color and taste of the red-banded lobster powder, thereby maximizing the rich taste and color of broth when the red-banded lobster powder is brewed in broth.

The roasted red-banded lobster powder is subdivided and packaged in a tea bag (S150).

Specifically, the roasted red-banded lobster powder is encapsulated in a filter paper or a filter mesh having a number of fine filter pores formed thereon, and is prepared in the form of a tea bag.

The packaging unit of the tea bag may be variously changed to 2 g, 4 g, 8 g, 10 g, 20 g, etc. as needed. For example, in the case of a tea bag for broth containing red-banded lobster powder used for cup noodles, the roasted red-banded lobster powder may be packaged to contain 2 g to 4 g in the tea bag. In addition, in the case of a tea bag for broth containing red-banded lobster powder used in preparing a large amount of meat broth, the roasted red-banded lobster powder may be packaged to contain 10 g or more.

The secondary packaging using paper or synthetic resin wrapping paper may be used to prevent contamination or deterioration by microorganisms due to contact with the outside during storage or distribution after the preparation of tea bags for broth containing red-banded lobster powder.

Additionally, the packaging of the roasted red-banded lobster powder in a tea bag may further include adding vegetable soup powder. Specifically, by adding vegetable soup powder to a tea bag containing red-banded lobster powder, it is possible to add more excellent flavor and a high-quality taste.

For example, the vegetable soup powder may be at least one of red pepper powder, mushroom powder, green onion powder, carrot powder, and seaweed powder, but is not limited thereto. In addition, the mushroom powder may be a powder prepared from at least one selected from enoki mushroom, shiitake mushroom, oyster mushroom, Clavaria botrytis, Cantharellus cibarius, Boletopsis leucomelaena (Pers.) Fayod, Sarcodon aspratus, and king oyster mushroom, but is not limited thereto.

Vegetable powder may be prepared by hot air drying a vegetable raw material, pulverizing the same, and removing impurities, but is not limited thereto. For example, it may further include roasting or quenching the vegetable raw material when needed.

The content of the vegetable soup powder included in the tea bag may be 20 to 50 parts by weight based on 100 parts by weight of the roasted red-banded lobster powder. Although not limited thereto, when the content of the vegetable soup powder satisfies the above range, the broth may be more refreshing and the light and umami taste may be improved.

The method for preparing a tea bag for broth containing red-banded lobster powder according to an embodiment of the present disclosure may provide a tea bag for broth that removes the fishy and miscellaneous smell of raw red-banded lobsters, preserves flavor, brews broth rich in umami taste, and is easy to use.

The method for preparing a tea bag for broth containing red-banded lobster powder according to an embodiment of the present disclosure provides a way of utilizing red-banded lobsters, which have many inedible parts compared to other raw materials. In other words, by providing a tea bag for broth using heads and shells, which are the inedible parts of red-banded lobsters, it is possible to utilize and save scavenged ingredients and create new added value.

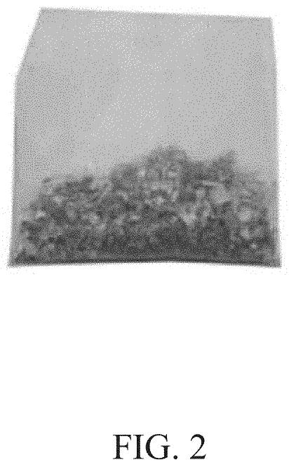

FIG. 2 is an image of a tea bag for broth containing red-banded lobster powder prepared according to an embodiment of the present disclosure. The tea bag for broth containing red-banded lobster powder according to an embodiment of the present disclosure contains roasted red-banded lobster powder having a particle size of 0.1 mm to 10 mm.

The tea bag for broth containing red-banded lobster powder according to an embodiment of the present disclosure may prepare broth rich in flavor and umami taste from which the fishy and miscellaneous smell has been removed by preparing the roasted red-banded lobster to have a specific particle size.

The tea bag for broth containing red-banded lobster powder may further include vegetable soup powder in order to improve flavor and add a high-quality taste. The vegetable soup powder may be at least one of red pepper powder, mushroom powder, green onion powder, carrot powder, and seaweed powder, but is not limited thereto.

The content of the vegetable soup powder included in the tea bag may be 20 to 50 parts by weight based on 100 parts by weight of the roasted red-banded lobster powder. Although not limited thereto, when the content of the vegetable soup powder satisfies the above range, the broth may be more refreshing and the light and umami taste may be improved.

The tea bag for broth containing red-banded lobster powder according to an embodiment of the present disclosure may be used for various foods in which the broth is brewed. For example, a tea bag for broth containing red-banded lobster powder may be used for ramen. By adding a tea bag containing red-banded lobster powder to solid ingredients of soup and soup powder used in the conventional ramen, it is possible to provide a new ramen with a flavor of red-banded lobster.

Hereinafter, the advantages of the present disclosure described above will be described in more detail through Examples and Comparative Examples. However, the following examples are for illustration of the present disclosure, and the scope of the present disclosure is not limited by the following examples.

### Example 1—Preparation of a Tea Bag for Broth Containing Red-Banded Lobster Powder

The selected raw red-banded lobsters were steamed at 65° C. for 6 hours, and then dried at 50° C. for 30 hours. The dried raw red-banded lobsters were pulverized and then roasted at 250° C. for 15 minutes to prepare red-banded lobster powder. The roasted red-banded lobster powder was subdivided into 2.5 g and packaged in a tea bag to prepare a tea bag for broth containing red-banded lobster powder.

The pulverized red-banded lobster powder had a particle size of 0.1 mm to 10 mm, and a ratio of powder having a particle size of 3 mm or more to powder having a particle size of less than 3 mm was about 1:1.

### Comparative Example 1

Except for the roasting process in Example 1, a tea bag for broth containing red-banded lobster powder was prepared in the same manner as in Example 1.

### Comparative Example 2

A tea bag for broth containing red-banded lobster powder was prepared in the same manner as in Example 1, except that the dried raw red-banded lobsters were pulverized in Example 1 and then artificially roasted for 15 minutes in a heated frying pan to prepare red-banded lobster powder.

### Comparative Example 3

A tea bag for broth containing red-banded lobster powder was prepared in the same manner as in Example 1, except that red-banded lobster powder having a particle size of less than 0.1 mm and more than 10 mm was included in the process of pulverizing the dried raw red-banded lobsters in Example 1.

### Experimental Example—Sensory Evaluation

Tea bags for broth containing red-banded lobster powder prepared in the Examples and Comparative Examples were prepared, and one tea bag having a volume of 2.5 g was added to about 300 mL of water and brewed for 5 minutes to prepare a flavored broth. A sensory test was performed on 30 users of the prepared flavored broth on a 5-point scale (5: very good, 4: good, 3: moderate, 2: poor, 1: very poor). As a result, the umami taste, flavor and smell are shown in Table 1 below.

TABLE 1

| Classification | Umami taste | Flavor | Smell | Overall score |
|---|---|---|---|---|
| Example 1 | 4.5 | 4.5 | 4 | 4.33 |
| Comparative | 3 | 4.5 | 4 | 3.83 |
| Example 1 | | | | |
| Comparative | 4 | 3.9 | 3.9 | 3.93 |
| Example 2 | | | | |
| Comparative | 4 | 3.5 | 3.5 | 3.67 |
| Example 3 | | | | |

As can be identified in Table 1 above, in the case of the tea bag for broth containing red-banded lobster powder using the roasting process, it was identified that all of umami taste, flavor, and smell were shown to have higher scores than those of the Comparative Examples. In addition, in comparison of Example 1 and Comparative Example 3, it was identified that the umami taste and flavor were improved according to the particle size of the pulverized red-banded lobster powder.

### Example 2—Preparation of a Tea Bag Containing Vegetable Soup Powder

50 parts by weight of vegetable soup powder based on 100 parts by weight of roasted red-banded lobster powder was added to a tea bag for broth containing red-banded lobster powder prepared in Example 1. The vegetable soup powder includes red pepper powder, mushroom powder, green onion powder, carrot powder and seaweed powder.

### Comparative Examples 4 to 6

50 parts by weight of vegetable soup powder based on 100 parts by weight of red-banded lobster powder roasted as in Example 2 was added to a tea bag for broth containing red-banded lobster powder prepared in Comparative Examples 1 to 3, respectively.

### Comparative Example 7

A tea bag was prepared in the same manner as in Example 2, except that the content of the added soup powder was 100 parts by weight based on 100 parts by weight of the roasted red-banded lobster powder.

### Experimental Example—Sensory Evaluation

Tea bags for broth containing red-banded lobster powder prepared in the Examples and Comparative Examples were prepared, and one tea bag having a volume of 2.5 g was added to about 300 mL of water and brewed for 5 minutes to prepare a flavored broth. A sensory test was performed on a 5-point scale (5: very good, 4: good, 3: moderate, 2: poor, 1: very poor). As a result, the umami taste, flavor and smell are shown in Table 2 below.

TABLE 2

| Classification | Umami taste | Flavor | Smell | Overall score |
|---|---|---|---|---|
| Example 2 | 4.6 | 4.5 | 5.0 | 4.70 |
| Comparative | 3.8 | 3.0 | 4.0 | 3.60 |
| Example 4 | | | | |
| Comparative | 4.3 | 3.9 | 4.2 | 4.13 |
| Example 5 | | | | |
| Comparative | 3.8 | 3.0 | 4.0 | 3.60 |
| Example 6 | | | | |
| Comparative | 3.0 | 3.0 | 4.0 | 3.33 |
| Example 7 | | | | |

In the case of sensory evaluation of a tea bag further containing vegetable soup powder, the results similar to those identified in Table 1 were identified. In other words, in comparison of Example 2 with Comparative Examples 4 and 5, in the case of the tea bag for broth containing red-banded lobster powder using the roasting process, it was identified that all of umami taste, flavor, and smell were shown to have higher scores than those of the Comparative Examples even when vegetable soup powder was used together.

Referring to Example 2 and Comparative Example 7, when the content of the vegetable soup powder was excessively added compared to the content of the red-banded lobster powder, it was identified that all of umami taste, flavor, and smell were shown to have low scores.

Although the exemplary embodiments of the present disclosure are described above in detail with reference to the accompanying drawings, the present disclosure is not limited thereto and may be embodied in many different forms without departing from the technical concept of the present disclosure. Therefore, the exemplary embodiments of the present disclosure are provided for illustrative purposes only and are not intended to limit the technical concept of the present disclosure. The scope of the technical concept of the present disclosure is not limited thereto. Therefore, it should be understood that the above-described exemplary embodiments are illustrative in all aspects and do not limit the present disclosure. The protective scope of the present disclosure should be construed based on the following appended claims, and all the technical concepts in the equivalent scope thereof should be construed as falling within the scope of the present disclosure.

What is claimed is:

1. A method for preparing a tea bag for broth containing red-banded lobster powder, the method comprising:
steaming raw red-banded lobsters at 50° C. to 100° C. for 2 to 10 hours;
drying the raw red-banded lobsters at 40° C. to 70° C. for 5 to 40 hours;
pulverizing the dried raw red-banded lobsters; and
roasting the pulverized red-banded lobster powder at 100° C. to 250° C. for 10 to 120 minutes.

2. The method of claim 1, further comprising separating meat from the raw red-banded lobsters before or after the drying process to obtain inedible parts of red-banded lobsters,
wherein the dried raw red-banded lobsters are heads or shells of the red-banded lobsters.

3. The method of claim 1,
wherein the pulverized red-banded lobster powder has a particle size of 0.1 mm to 10 mm, and
a ratio of powder having a particle size of 3 mm or more to powder having a particle size of less than 3 mm is 1:2 to 1:1.

4. The method of claim 1, further comprising subdividing the roasted red-banded lobster powder into 2 g to 4 g and packaging the powder in a tea bag.

5. The method of claim 4, further comprising:
adding 20 to 50 parts by weight of vegetable soup powder based on 100 parts by weight of the roasted red-banded lobster powder to the tea bag,
wherein the vegetable soup powder includes at least one of pepper powder, mushroom powder, green onion powder, carrot powder, and seaweed powder.

6. A tea bag for broth containing red-banded lobster powder prepared by the preparation method of claim 1.
